(19) United States
(12) Patent Application Publication
(10) Pub. No.: US 2022/0128824 A1
(43) Pub. Date: Apr. 28, 2022

(54) HEAD MOUNTED DISPLAY AND LIGHT CONTROLLER

(71) Applicant: SONY GROUP CORPORATION, TOKYO (JP)

(72) Inventor: TAKAAKI YOSHIDA, TOKYO (JP)

(21) Appl. No.: 17/429,812

(22) PCT Filed: Dec. 18, 2019
(86) PCT No.: PCT/JP2019/049711

§ 371 Date: Aug. 10, 2021

(30) Foreign Application Priority Data
Feb. 19, 2019 (JP) 2019-027752

(51) Int. Cl. G02B 27/01

(52) U.S. Cl. CPC G02B 27/0176; G02B 2027/0154; G02B 27/0172

(57) ABSTRACT

A head mounted display includes a frame and an optical member that is fixed to the frame and provides an image. The frame includes a pair of attaching and detaching units to which both ends of a light controller are detachably attached. At least one of the pair of attaching and detaching units is electrically connected to at least one of the both ends of the light controller.

### FIELD

This disclosure relates to a head mounted display and a light controller.

### BACKGROUND

Augmented Reality (AR) has attracted attention in recent years. This technology enables a user to see additional information such as images and texts superimposed on a scene in front of his/her eyes. A head mounted display (HMD) is known as an AR device for achieving augmented reality.

### CITATION LIST

### Patent Literature

Patent Literature 1: JP 2012-252091 A
Patent Literature 2: JP 2017-103767 A

### SUMMARY

### Technical Problem

However, the techniques in the related art do not provide a head mounted display with a high level of operability. Specifically, a head mounted display may include a light controller that changes in transmittance along with the application of a voltage. Such a light controller is connected to the body of the head mounted display by a wire and is not easily attached to or detached from the head mounted display. Accordingly, it cannot be said that the head mounted display has a high level of operability.

The operability not at a high level may also be a problem in other types of head mounted displays as well as those used for AR. The problem may occur in, for example, eyeglasses, a head mounted display including a light controller that changes in transmittance along with the application of a voltage.

Accordingly, this disclosure proposes a head mounted display and a light controller that enhance the operability.

### Solution to Problem

According to the present disclosure, a head mounted display includes a frame; and an optical member fixed to the frame and configured to provide an image, wherein the frame includes a pair of attaching and detaching units to which both ends of a light controller are detachably attached, and at least one of the pair of attaching and detaching units is electrically connected to at least one of the both ends of the light controller.

According to the present disclosure, a light controller includes a base material having flexibility and a flat-plate shape; a light controlling material disposed on the base material and having a flat-plate shape; a pair of attached portions disposed at both ends of the base material and detachably attached to a pair of attaching and detaching units of a frame of a head mounted display; and an electrical connector disposed on at least one of the pair of attached portions and electrically connected to at least one of the pair of attaching and detaching units of the frame.

### BRIEF DESCRIPTION OF DRAWINGS

FIG. 1 is a perspective view schematically illustrating a head mounted display according to an embodiment.

FIG. 2 is a view schematically illustrating a cross section taken along arrow A-A in FIG. 1.

FIG. 3 is a perspective view schematically illustrating the head mounted display according to the embodiment.

FIG. 4 is a front view schematically illustrating the head mounted display according to the embodiment.

FIG. 5 is a perspective view illustrating a part of a light controller according to the embodiment.

FIG. 6 is a side view illustrating a part of the light controller according to the embodiment.

FIG. 7 is a front view schematically illustrating the light controller according to the embodiment.

FIG. 8 is a front view schematically illustrating the light controller according to the embodiment.

FIG. 9 is a perspective view illustrating a part of an extended portion according to the embodiment.

FIG. 10 is a perspective view illustrating a part of the light controller and a part of the extended portion according to the embodiment.

FIG. 11 is a front view illustrating a part of the light controller and a part of the extended portion according to the embodiment.

FIG. 12 is a view schematically illustrating a cross section taken along arrow B-B in FIG. 11.

FIG. 13 is a perspective view illustrating a part of a light controller and a part of an extended portion according to a modification.

FIG. 14 is a front view of the light controller and the extended portion according to the modification.

FIG. 15 is a view schematically illustrating a cross section taken along arrow C-C in FIG. 14.

FIG. 16 is a front view schematically illustrating the light controller according to the embodiment.

FIG. 17 is a view for explaining applied voltages.

FIG. 18 is a view illustrating examples of voltages applied to the light controlling material.

FIG. 19 is a view illustrating an example of a wiring pattern according to a modification.

FIG. 20 is a view illustrating examples of voltages applied to a light controlling material according to the modification.

FIG. 21 is a view illustrating an example of a wiring pattern according to a modification.

FIG. 22 is a view illustrating examples of voltages applied to a light controlling material according to the modification.

FIG. 23 is a view illustrating an example of a wiring pattern according to a modification.

FIG. 24 is a view illustrating examples of voltages applied to a light controlling material according to the modification.

FIG. 25 is a view illustrating an example of a wiring pattern according to a modification.

FIG. 26 is a view illustrating examples of voltages applied to a light controlling material according to the modification.

FIG. 27 is a front view schematically illustrating a light controller according to a modification.

FIG. 28 is a perspective view schematically illustrating an optical member and a light controller according to a modification.

FIG. 29 is a view schematically illustrating a cross section of a head mounted display according to a modification.

### DESCRIPTION OF EMBODIMENTS

Hereinafter, embodiments of this disclosure will be described in detail with reference to the drawings. In each of the following embodiments, the same parts will be denoted with the same reference numerals, and overlapping content will not be described. Furthermore, for ease of comprehension, some drawings illustrate a three-dimensional Cartesian coordinate system including Y axis. The upward direction of Y axis represents the positive direction, while the downward direction thereof represents the negative direction. The Cartesian coordinate system may have some margin of orientation error between the drawings, and this disclosure is not limited to the illustrated directions.

The explanation is given in the following order.

1. Exterior of head mounted display

2. Attachment and detachment mechanism (1)

3. Attachment and detachment mechanism (2)

4. Wiring pattern

5. Modification

6. Effect

### 1. Exterior of Head Mounted Display

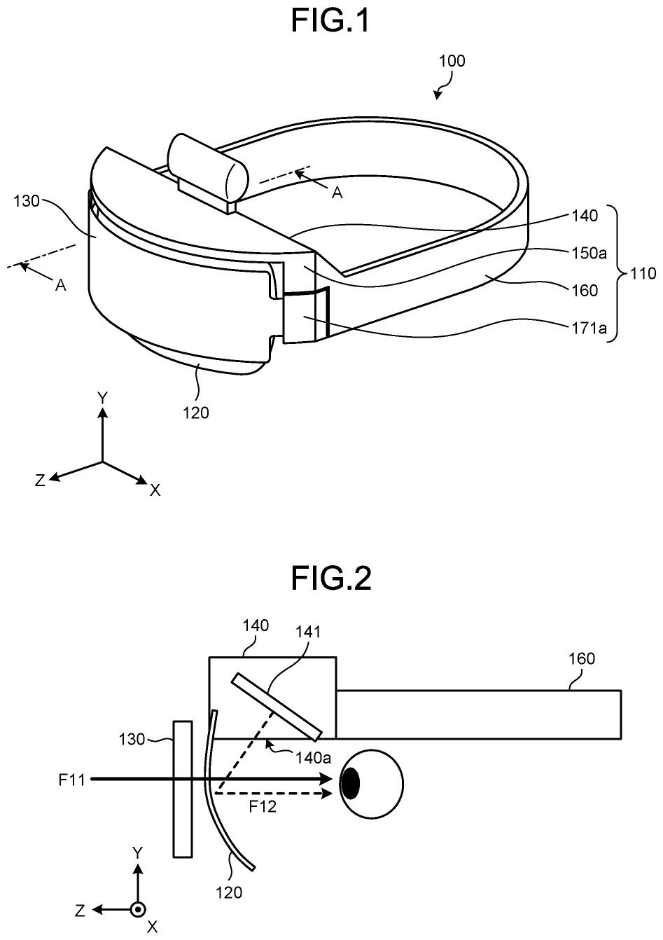

First, the configuration of a transmissive head mounted display 100 according to this disclosure will be described with reference to FIGS. 1 and 2. FIG. 1 is a perspective view schematically illustrating the head mounted display 100 according to an embodiment. FIG. 2 is a view schematically illustrating a cross section taken along arrow A-A in FIG. 1.

The head mounted display 100 according to this embodiment is an AR device which is to be mounted on a watcher's head. The head mounted display 100 provides light (image light) of various types of information in front of watcher's eyes along with external light. The head mounted display 100 enables the watcher to see a scene in the real space with a virtual object superimposed and displayed thereon. As illustrated in FIG. 1, the head mounted display 100 includes a frame 110, an optical member 120, and a light controller 130. In FIG. 1, for example, the positive direction of Z axis is a line-of-sight direction of the watcher.

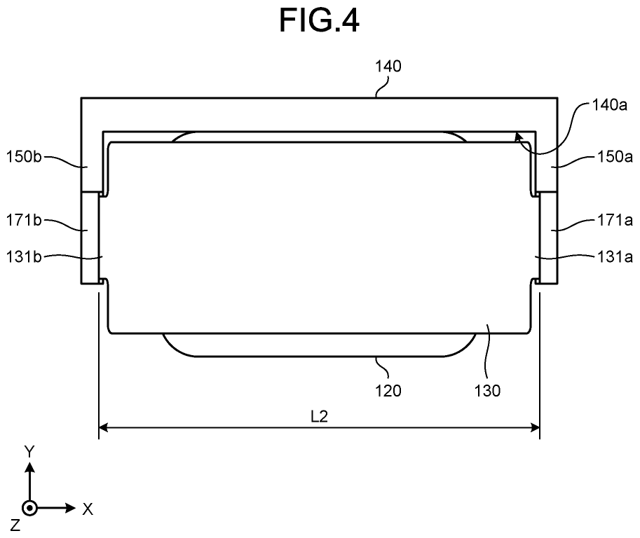

The frame 110 is a part to be mounted on the watcher's head. The frame 110 includes a substrate 140, an extended portion 150a, and a fastener 160. Although it is in the blind spot in FIG. 1, an extended portion (an extended portion 150b illustrated in FIG. 4) is included in the frame 110 at the opposite position of the extended portion 150a. The frame 110 also includes a fixing member 171a which is to be described later.

In the frame 110, the substrate 140 is disposed toward the line-of-sight direction of the watcher. In FIG. 1, for example, the substrate 140 is formed into a semicircular flat plate. The extended portions 150a and 150b are flat plates extended in a predetermined direction from the substrate 140. Specifically, the extended portions 150a and 150b are extended in a direction away from one surface 140a (see FIG. 2) of the substrate 140. As will be described later, the extended portions 150a and 150b hold the light controller 130 when the light controller 130 is mounted thereon. The fastener 160 is formed into a semicircular shape. One end of the fastener 160 is connected to the extended portion 150a, and the other end of the fastener 160 is connected to the extended portion 150b. The fastener 160 is stretchable and the watcher's head can be fixed by the fastener 160.

The substrate 140 will now be described with reference to FIG. 2. For ease of comprehension, FIG. 2 illustrates the fastener 160 in addition to the cross section taken along arrow A-A in FIG. 1. As illustrated in FIG. 2, the substrate 140 includes a display device 141. The display device 141 emits an image to present various kinds of images and information to the watcher. The various kinds of images and information to be presented may be information that is displayed based on data sent from a content distribution server or the like or may be information stored in a memory mounted on the head mounted display 100. Alternatively, the various kinds of images and information to be presented may be data stored in a mobile terminal or a personal computer (PC) of a user which is acquired by the head mounted display 100. The user of the mobile terminal may be the same as or different from the watcher.

The substrate 140 may also include a board (not illustrated). The board performs processing to provide an image to the watcher. For example, the board includes a controller that controls the operation of the head mounted display 100, a memory that stores data, and a communication unit that communicates with an external device. The controller of the board includes, for example, a central processing unit (CPU), a read only memory (ROM), and a random access memory (RAM).

The display device 141 illustrated in FIG. 2 may include right and left panel light emitting units corresponding to both eyes of the watcher. In this case, the right and left panel light emitting units emit virtual images for the right and left eyes, respectively.

The substrate 140, extended portions 150a and 150b, and fastener 160 described above are formed in an integrated manner. However, the present invention is not limited to this example, and one or all of the substrate 140, extended portions 150a and 150b, and fastener 160 may be formed from different pieces. In this case, the pieces are fixed to each other, for example, with a screw, by bonding or by fitting.

The optical member 120 reflects image light emitted from the display device 141. Accordingly, the optical member 120 provides the watcher with various kinds of images and information. The optical member 120 is, for example, a half mirror and includes a material such as glass. That is, among the surfaces of the optical member 120, a surface that faces the watcher (a surface that provides images) enables light reflection, and a surface opposite to the surface facing the watcher (a surface that faces the light controller 130 to be described) enables transmission of external light. The optical member 120 is fixed to the frame 110, for example, with a screw, by bonding or by fitting. In FIG. 2, for example, the optical member 120 is fixed to one surface 140a of the substrate 140 and extends while being curved in a direction away from the surface 140a. However, the optical member 120 may be formed into a flat plate instead of being curved.

The light controller 130 is an electrochromic device and includes a flexible member. For example, the light controller 130 is formed by sandwiching an electrochromic element between transparent electrodes. The electrochromic element develops an oxidation reaction or a reduction reaction according to the voltage applied to the transparent electrodes. Accordingly, the transmittance of the light controller 130 is controlled. When the head mounted display 100 is used in a bright outdoor environment, the display luminance may be insufficient relative to external light. In such a case, the transmittance of the light controller 130 is controlled so as to ensure the visibility of the head mounted display 100. The light controller 130 includes, for example, a material obtained by applying an antireflection coating to an acrylic transparent resin. Alternatively, the light controller 130 includes polycarbonate, acrylic, or nylon.

The image output of the head mounted display 100 will be described with reference to FIG. 2. As illustrated in direction F11 in FIG. 2, according to the transmittance of the light controller 130, external light passes through the light controller 130 and then through the optical member 120 and reaches the watcher. That is, the watcher can see a scene in the real space or the like while wearing the head mounted display 100. Furthermore, as illustrated in direction F12 in FIG. 2, image light emitted from the display device 141 is reflected by the optical member 120 and reaches the watcher. That is, the watcher can see the image provided by the display device 141. In this manner, the head mounted display 100 provides the watcher with augmented reality in which an image is superimposed and displayed on a scene in real space.

As described above, the transmittance of the light controller 130 is controlled by the application of a voltage. In order to apply a voltage to the light controller 130, it is required that the frame 110 including the board is electrically connected to the light controller 130. On the other hand, depending on the watcher, the light controller 130 may be detached from the head mounted display 100, or the light controller 130 may be attached to the head mounted display 100. For example, to acquire 100% of the transmittance, it is inferred that the light controller 130 is detached from the head mounted display 100. Alternatively, for example, when the light controller 130 breaks down, or when light controllers 130 with different functions are employed depending on the intended use, the light controller 130 is replaced with another one. However, forcing the watcher to perform electrical connection between the head mounted display 100 and the light controller 130 causes reduction in usability of the head mounted display 100.

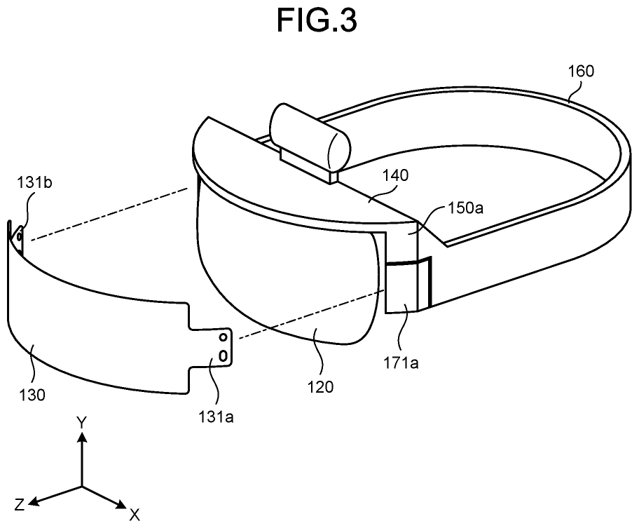

Therefore, in the head mounted display 100 according to the embodiment, the light controller 130 can be attached to and detached from the frame 110. Being mounted with the light controller 130, the frame 110 is electrically connected to the light controller 130. This point will be briefly described with reference to FIGS. 3 and 4. FIG. 3 is a perspective view schematically illustrating the head mounted display 100 according to the embodiment. FIG. 3 illustrates a state where the light controller 130 is detached. FIG. 4 is a front view schematically illustrating the head mounted display 100 according to the embodiment. FIG. 4 illustrates a view seen in the negative direction of Z axis.

As illustrated in FIG. 3, the light controller 130 includes a pair of attached portions 131a and 131b. The attached portion 131a is an area of the light controller 130 that protrudes from one end. An electrode or one end of a wire disposed on the light controller 130 is arranged on the attached portion 131a. Similarly, the attached portion 131b is an area protruding from the other end of the light controller 130, and an electrode of a wire disposed on the light controller 130 is arranged on the attached portion 131b.

As illustrated in FIGS. 3 and 4, the frame 110 includes fixing members 171a and 171b. The attached portion 131a is held between the fixing member 171a and the extended portion 150a. Similarly, the attached portion 131b is held between the fixing member 171b and the extended portion 150b. Furthermore, the extended portions 150a and 150b are provided with electrical ground points (conductors to be described) for the wires that are electrically connected to the board of the substrate 140.

In the head mounted display 100 according to the embodiment, the attached portion 131a is fixed to the frame 110 by the fixing member 171a, and the attached portion 131b is fixed to the frame 110 by the fixing member 171b. When the attached portion 131a is fixed by the fixing member 171a, the electrode of the wire disposed on the attached portion 131a and the conductor disposed on the extended portion 150a are electrically connected to each other. Similarly, when the attached portion 131b is fixed by the fixing member 171b, the electrode of the wire disposed on the attached portion 131b and the conductor disposed on the extended portion 150b are electrically connected to each other. That is, in the head mounted display 100, mounting the light controller 130 on the frame 110 enables electrical connection between the light controller 130 and the frame 110. This makes it possible to attach or detach the light controller 130 without having the watcher perform the task of electrical connection, which enhances the operability of the head mounted display 100.

### 2. Attachment and Detachment Mechanism (1)

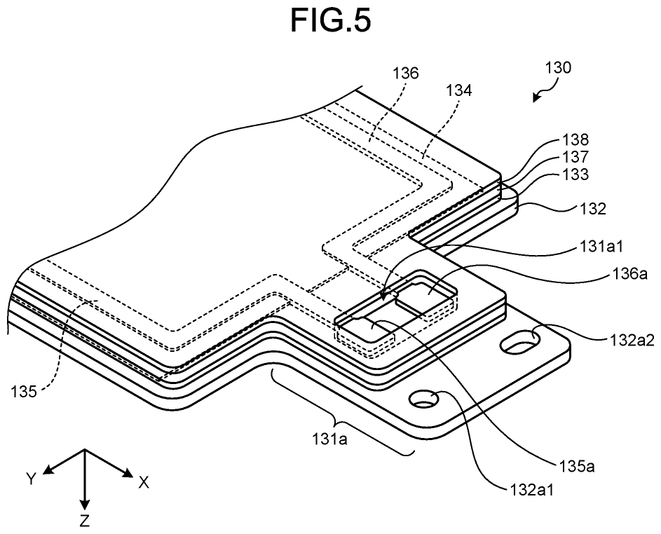

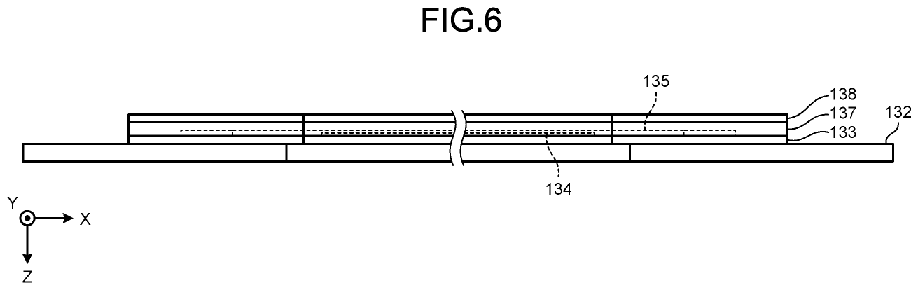

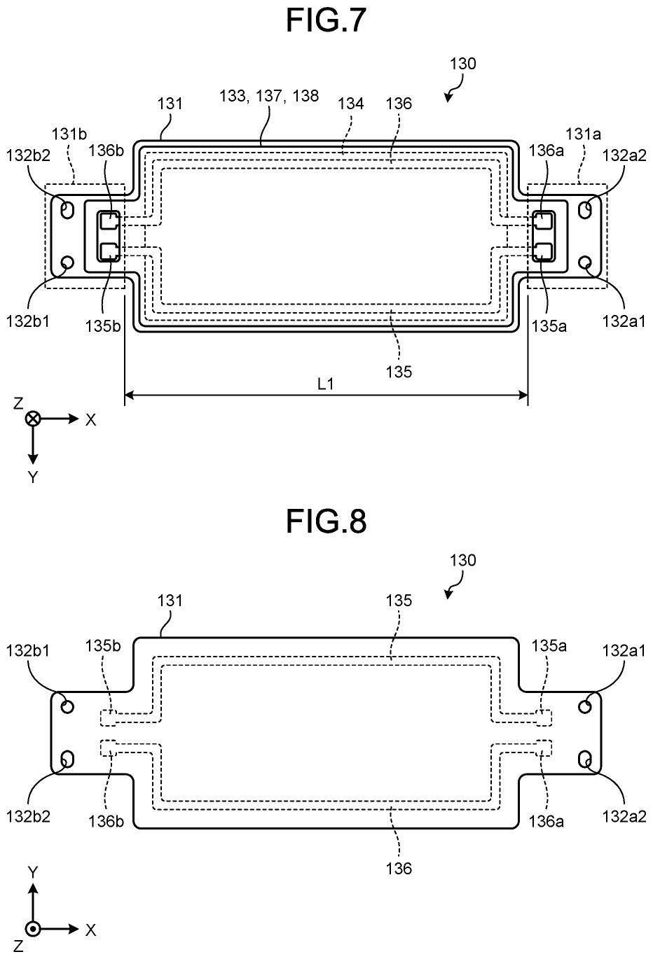

Hereinafter, the attachment and detachment mechanism of the light controller 130 according to the embodiment will be described in detail. First, the light controller 130 will be described with reference to FIGS. 5 to 8. FIG. 5 is a perspective view illustrating a part of the light controller 130 according to the embodiment. FIG. 6 is a side view illustrating a part of the light controller 130 according to the embodiment. FIG. 6 illustrates a view seen in the negative direction of Y axis. FIGS. 7 and 8 are front views schematically illustrating the light controller 130 according to the embodiment. FIG. 7 illustrates a view seen in the positive direction of Z axis. FIG. 8 illustrates a view seen in the negative direction of Z axis. FIGS. 7 and 8 are inverted with respect to each other in the vertical direction. Hereinafter, one of the right and left sides (for example, one of the attached portions 131a and 131b) may be described, but note that both sides have a similar configuration.

As illustrated in FIGS. 5 and 6, the light controller 130 has a flat-plate shape when not being attached before being attached to the head mounted display 100. The light controller 130 includes a cover plate 132, a lower plate 133, a light controlling material 134, wires 135 and 136, an adhesive member 137, and an upper plate 138.

The cover plate 132 is flexible and formed into a flat plate. The cover plate 132 includes, for example, a transparent resin.

The lower plate 133 is stacked on the cover plate 132. Specifically, the lower plate 133 has a shape smaller than that of the cover plate 132 and is stacked on the cover plate 132 in such a manner that the entire lower plate 133 overlaps with the cover plate 132 in a plan view. The lower plate 133 includes, for example, a transparent resin.

The light controlling material 134 includes, for example, an electrochromic element and controls light passing through the light controller 130. Specifically, the light controlling material 134 is formed by sandwiching an electrochromic element between transparent electrodes. The light controlling material 134 is stacked on the cover plate 132 and the lower plate 133. Specifically, the light controlling material 134 has a shape smaller than that of the lower plate 133 and is stacked on the lower plate 133 in such a manner that the entire light controlling material 134 overlaps with the lower plate 133 in a plan view.

The wires 135 and 136 are a wiring pattern disposed on the light controller 130 and apply a voltage to the light controlling material 134. The wires 135 and 136 are, for example, Cu wire and Ag wire. One of the wires 135 and 136 is the positive electrode and the other is the negative electrode. Herein, the wire 135 is the positive electrode and the wire 136 is the negative electrode. However, the wire 135 may be the negative electrode and the wire 136 may be the positive electrode. The wire 135 is connected to one transparent electrode of the light controlling material 134, and the wire 136 is connected to the other transparent electrode of the light controlling material 134. Accordingly, a voltage is applied to the light controlling material 134. As illustrated in FIGS. 7 and 8, electrodes 135a and 135b are disposed at both ends of the wire 135. Furthermore, electrodes 136a and 136b are disposed at both ends of the wire 136. The electrodes 135a, 135b, 136a, and 136b each are an example of an electrical connector.

The adhesive member 137 is a transparent and elastic adhesive. The adhesive member 137 is, for example, an optical clear adhesive (OCA). The adhesive member 137 is stacked on the lower plate 133 to seal the light controlling material 134 and the wires 135 and 136. The adhesive member 137 preferably includes a material having a low bending modulus of elasticity. For example, the adhesive member 137 has a lower bending modulus of elasticity than the cover plate 132, the lower plate 133, and the upper plate 138. This makes it difficult to apply stress to the light controller 130 even when it is bent, which enhances the reliability of the light controller 130.

The upper plate 138 is stacked on the adhesive member 137. The upper plate 138 has a similar size to the lower plate 133. Furthermore, the upper plate 138 includes, for example, a transparent resin as similar to the lower plate 133.

The cover plate 132, the lower plate 133, the adhesive member 137, and the upper plate 138 are a flexible base material and correspond to a base material provided with the light controlling material 134 and the wires 135 and 136. For example, the cover plate 132, the lower plate 133, the adhesive member 137, and the upper plate 138 functioning as a base material seal the light controlling material 134 and the wires 135 and 136.

As illustrated in FIGS. 7 and 8, the cover plate 132 protrudes from central parts of both sides of a substantially rectangular shape in a plan view. Furthermore, the lower plate 133, the adhesive member 137, and the upper plate 138 protrude from the central part of each side of the substantially rectangular shape as similar to the cover plate 132. The protruding areas correspond to the attached portions 131a and 131b. As illustrated in FIG. 5, a through hole is formed in a part of each area of the adhesive member 137 and the upper plate 138 that protrudes toward the attached portion 131a.

Accordingly, the attached portion 131a is formed with an opening 131a1. The electrodes 135a and 136a disposed in the attached portion 131a are exposed from the opening 131a1. The attached portion 131b has a similar configuration, and the electrodes 135b and 136b are exposed from an opening (not illustrated).

As illustrated in FIG. 7, positioning holes 132a1 and 132a2 or through holes for positioning are formed in an end of the cover plate 132 within an area of the attached portion 131a. Similarly, positioning holes 132b1 and 132b2 are formed in an area of the cover plate 132 corresponding to an end of the attached portion 131b. The positioning holes 132a1 and the like are used to determine the position of the light controller 130 on the frame 110. This point will be described later.

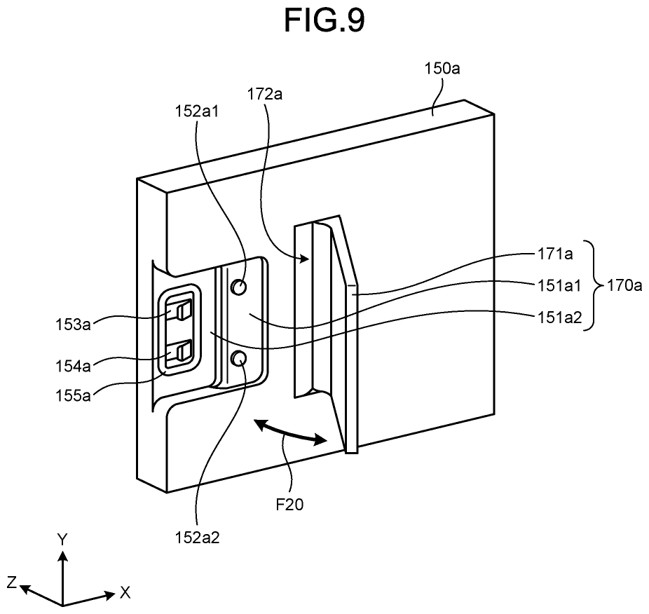

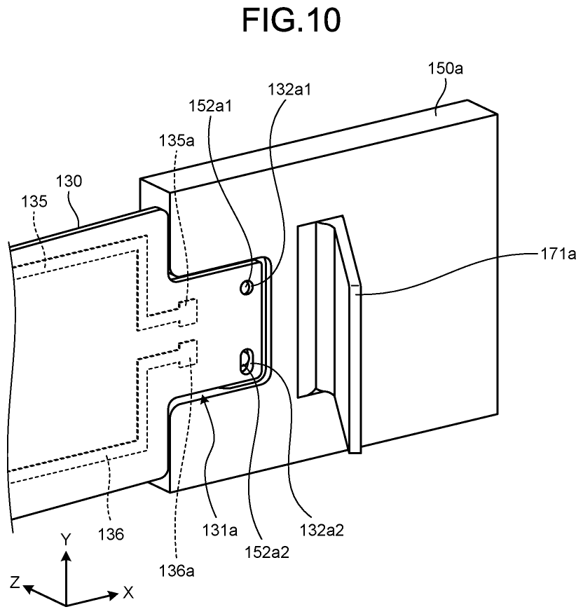

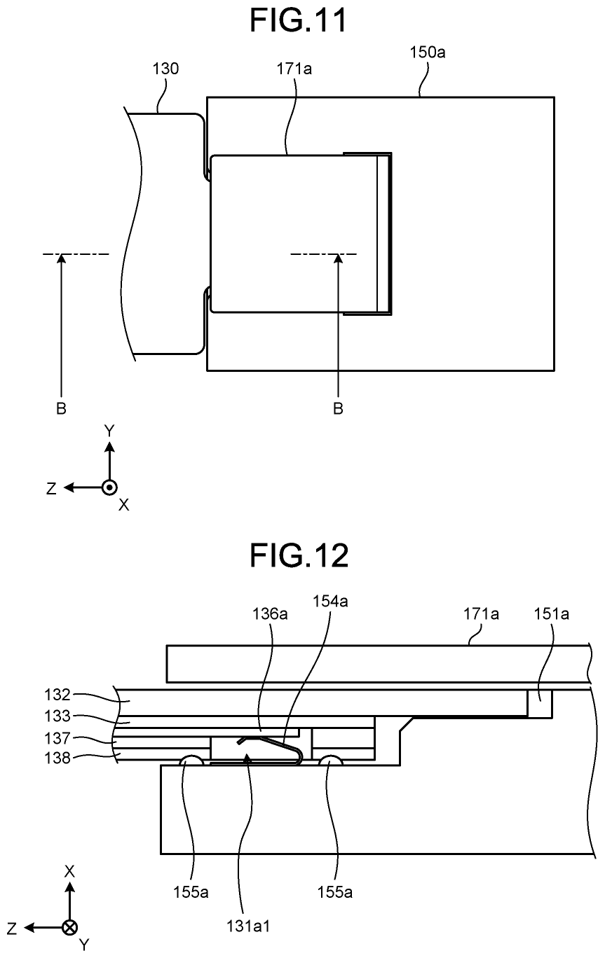

Next, the attachment and detachment mechanism of the light controller 130 will be described with reference to FIGS. 9 to 12. FIG. 9 is a perspective view illustrating a part of the extended portion 150a according to the embodiment. FIG. 10 is a perspective view illustrating a part of the light controller 130 and a part of the extended portion 150a according to the embodiment. FIG. 11 is a front view illustrating a part of the light controller 130 and a part of the extended portion 150a according to the embodiment. FIG. 11 illustrates a view seen in the negative direction of X axis. FIG. 12 is a view schematically illustrating a cross section taken along arrow B-B in FIG. 11.

As illustrated in FIG. 9, the extended portion 150a is formed with a first cutout 151a1 having a surface partially cut into a substantially rectangular shape. The first cutout 151a1 is formed with a second cutout 151a2 having a surface partially cut into a substantially rectangular shape. The first cutout 151a1 is formed with positioning pins 152a1 and 152a2. Furthermore, the second cutout 151a2 is provided with conductors 153a and 154a. The conductors 153a and 154a are electrical contacts and are connected to the board of the substrate 140 by wires. Furthermore, the second cutout 151a2 is provided with a waterproof member 155a that surrounds the conductors 153a and 154a. The waterproof member 155a is, for example, rubber and is referred to as “packing” or the like.

As illustrated in FIG. 9, the fixing member 171a is formed into a flat plate and is pivotably fixed to the extended portion 150a centering on one end 172a. In FIG. 9, for example, the fixing member 171a pivots in direction F20. Specifically, the fixing member 171a pivots in directions in which the fixing member 171a moves to or from the first cutout 151a1 of the extended portion 150a. The pivoting mechanism by the one end 172a has a locking mechanism. When the fixing member 171a moves to the extended portion 150a to such an extent that the fixing member 171a becomes substantially parallel to the surface of the extended portion 150a, the locking mechanism locks the fixing member 171a unless a certain degree of stress or more is applied in the direction away from the first cutout 151a1.

The attached portion 131a is attached to and detached from a space formed by the fixing member 171a, the first cutout 151a1, and the second cutout 151a2. That is, the fixing member 171a, the first cutout 151a1, and the second cutout 151a2 correspond to an attaching and detaching unit 170a included in the frame 110. Although not illustrated, the extended portion 150b has a configuration similar to one illustrated in FIG. 9. Accordingly, the frame 110 also includes an attaching and detaching unit (referred to as “attaching and detaching unit 170b”) on the extended portion 150b.

As illustrated in FIGS. 10 and 12, the attached portion 131a of the light controller 130 is placed on the first cutout 151a1 and the second cutout 151a2. Specifically, in the attached portion 131a, the cover plate 132 is placed on the first cutout 151a1, and the lower plate 133, adhesive member 137, and upper plate 138 are placed on the second cutout 151a2. In other words, the first cutout 151a1 has a shape that enables accommodation of the cover plate 132 of the attached portion 131a. Furthermore, the second cutout 151a2 has a shape that enables accommodation of the lower plate 133, adhesive member 137, and upper plate 138 of the attached portion 131a.

At this time, the positioning pin 152a1 is inserted into the positioning hole 132a1, and the positioning pin 152a2 is inserted into the positioning hole 132a2. Accordingly, the position of the light controller 130 is determined with respect to the extended portion 150a. Specifically, when the positioning pin 152a1 is inserted into the positioning hole 132a1, the outer wall of the positioning pin 152a1 abuts on the inner wall of the positioning hole 132a1, which leads to positioning of the light controller 130. With only the positioning pin 152a1, the light controller 130 rotates about the positioning pin 152a1. However, with the positioning pin 152a2 inserted into the positioning hole 132a2, the light controller 130 is prevented from rotating.

The positioning hole 132a1 has a shape that allows the positioning pin 152a1 to be inserted thereinto and has a size substantially equal to that of the positioning pin 152a1. The positioning hole 132a2 has a shape that allows the positioning pin 152a2 to be inserted thereinto but has an elongated hole shape. More specifically, the positioning hole 132a2 is formed into an elongated hole in which a side (Y-axis direction) connecting the positioning pin 152a1 with the positioning hole 132a2 is long. This is because the positioning hole 132a2 and the positioning pin 152a2 having a substantially equal size may cause a difficulty in inserting the positioning pins 152a1 and 152a2 into the positioning holes 132a1 and 132a2 due to manufacturing errors and the like. Furthermore, as described above, since the positioning hole 132a2 is intended to prevent the rotation about the positioning pin 152a1, the positioning hole 132a2 is not required to abut on the positioning pin 152a2 in Y-axis direction which is not the rotation direction. This is why the positioning hole 132a2 has an elongated hole shape in which the side toward Y-axis direction is long.

As illustrated in FIG. 11, the fixing member 171a pivots in the direction approaching the extended portion 150a so as to lock the light controller 130. Accordingly, the light controller 130 is held by the attaching and detaching unit 170a of the extended portion 150a. As illustrated in FIG. 12, when the light controller 130 is mounted, the electrode 135a exposed from the attached portion 131a abuts on the conductor 153a, and the electrode 136a abuts on the conductor 154a. Accordingly, the light controller 130 and the frame 110 are electrically connected to each other. That is, at the time the light controller 130 is mounted on the frame 110, the light controller 130 and the frame 110 are electrically connected to each other.

Furthermore, as illustrated in FIG. 12, when the attached portion 131a is fixed to the extended portion 150a, the waterproof member 155a is pressed against the surface of the upper plate 138 around the opening 131a1 so as to seal the conductors 153a and 154a inside the opening 131a1. This makes it possible to prevent water and dust from entering the opening 131a1 from outside. That is, electrical parts such as the conductors 153a and 154a are reliably protected from water and dust.

When the fixing member 171a pivots in a direction away from the extended portion 150a, the attached portion 131a is detached from the extended portion 150a. The attached portion 131b and the extended portion 150b have similar mechanisms as those illustrated in FIGS. 9 to 12. For example, the extended portion 150b includes conductors (referred to as “conductors 153b and 154b”) corresponding to the conductors 153a and 154a.

As described above, the pair of attaching and detaching units 170a and 170b enables detachable attachment of the attached portions 131a and 131b that are disposed at both ends of the light controller 130. As described with reference to FIG. 6, the light controller 130 has a flat-plate shape when not being attached. When the light controller 130 is not mounted, a length connecting the pair of attached portions 131a and 131b (L1 illustrated in FIG. 7) is longer than a length connecting the pair of attaching and detaching units 170a and 170b of the frame 110 (L2 illustrated in FIG. 4). That is, as illustrated in FIG. 1, the pair of attaching and detaching units 170a and 170b holds the light controller 130 in a curved state when the attached portions 131a and 131b are mounted on the pair of attaching and detaching units 170a and 170b. Specifically, the pair of attaching and detaching units 170a and 170b holds the light controller 130 while the light controller 130 is curved so as to protrude in a direction away from the optical member 120 so as to follow the curved surface of the optical member 120. The pair of attaching and detaching units 170a and 170b holds the light controller 130 in such a manner that the upper plate 138 of the light controller 130 and the optical member 120 face each other. That is, the cover plate 132 of the light controller 130 is placed on the outer side of the head mounted display 100.

The pair of attaching and detaching units 170a and 170b holds the pair of attached portions 131a and 131b while the pair of attached portions 131a and 131b are curved so as to approach each other. Therefore, the light controller 130 is gently curved in an arc shape about a direction in which the extended portions 150a and 150b extend (Y-axis direction). In other words, the light controller 130 is not curved in an arc shape about a direction connecting the pair of attached portions 131a and 131b (X-axis direction). That is, the attached portions 131a and 131b themselves are not curved greatly and remain substantially flat. This makes it possible to prevent the electrode 135a and the like disposed on the attached portions 131a and 131b from being deformed or damaged by curving.

As illustrated in FIG. 4, the extended portions 150a and 150b, or the attaching and detaching units 170a and 170b, are disposed at positions to sandwich the optical member 120. Accordingly, the pair of attaching and detaching units 170a and 170b holds the light controller 130 to cover the optical member 120. Therefore, the head mounted display 100 allows light passing through the light controller 130 to reach the optical member 120. The optical member 120 being sandwiched between the attaching and detaching units 170a and 170b indicates that the optical member 120 is disposed between the attaching and detaching units 170a and 170b in a plan view as illustrated in FIG. 4.

When the light controller 130 is mounted, the pair of attaching and detaching units 170a and 170b holds the light controller 130 while the optical member 120 and the light controller 130 are separated from each other. That is, the light controller 130 does not abut on the optical member 120 when being mounted on the head mounted display 100. This makes it possible to maintain optical properties of the optical member 120. This point will be described specifically. A positional relation of the optical member 120 and the display device 141 is determined accurately in order to provide an image to a watcher. For this reason, when an external force or the like shifts the fixed position of the optical member 120, the head mounted display 100 may deteriorate in display performance. The display performance may be deteriorated by, for example, a force applied when a watcher wipes the optical member 120 at cleaning, a force applied when a watcher grips or carries the optical member 120, or an external force caused by a drop impact. In the head mounted display 100 according to the embodiment, the optical member 120 and the light controller 130 are separated from each other. Accordingly, an external force applied to the light controller 130 can be prevented from being easily transmitted to the optical member 120, which makes it possible to maintain the optical properties of the optical member 120 and eventually prevents deterioration of the head mounted display 100 in display performance.

Furthermore, the pair of attaching and detaching units 170a and 170b holds the light controller 130 on a side of the optical member 120 opposite to the side where an image is provided (the side of the optical member 120 facing a watcher). That is, the light controller 130 is held at a position where the optical member 120 is sandwiched between the light controller 130 and the fastener 160. Therefore, the light controller 130 and the fastener 160 are disposed on the outer side of the head mounted display 100. Accordingly, it is difficult to apply an external force to the optical member 120, which eventually prevents deterioration of the head mounted display 100 in display performance. Still further, as described above, since the light controller 130 is held in a curved state, it is possible to disperse an external force applied to the light controller 130. Even from this viewpoint, it is possible to prevent the head mounted display 100 according to the embodiment from deteriorating in display performance.

### 3. Attachment and Detachment Mechanism (2)

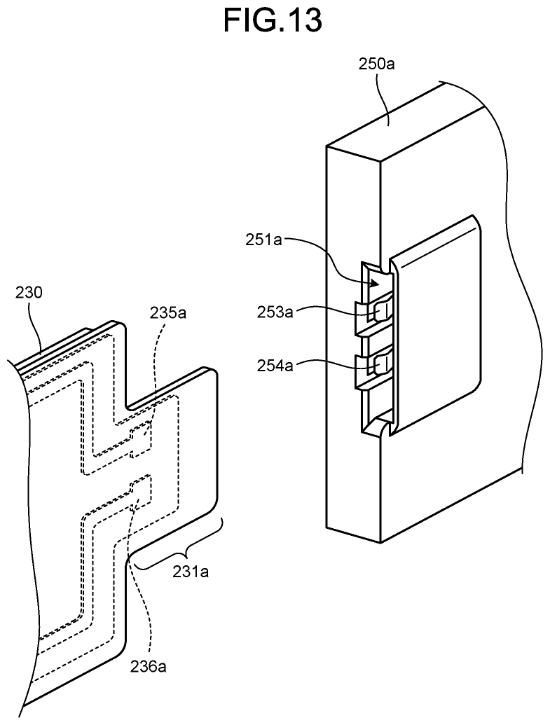

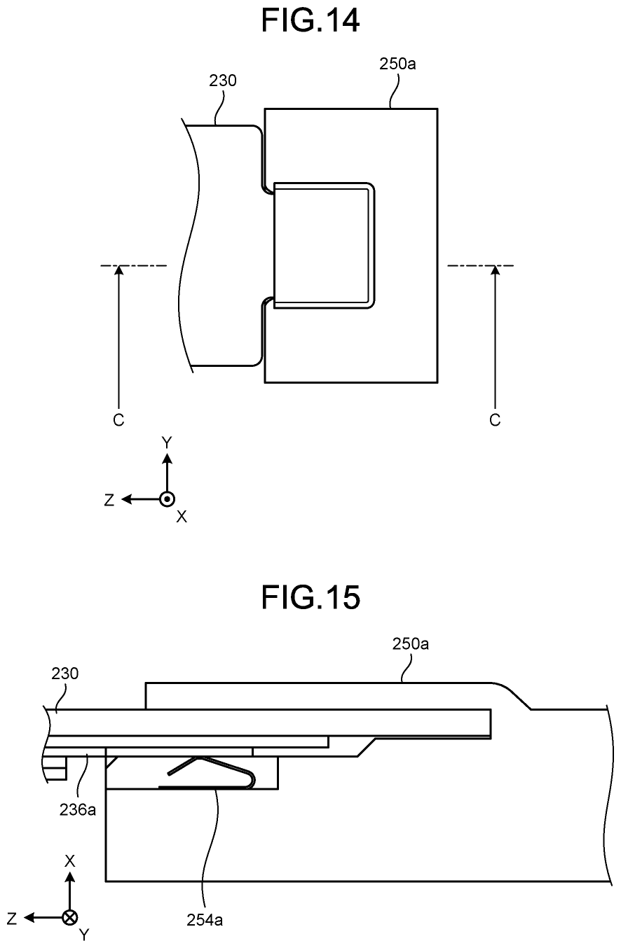

The preceding paragraphs shows an example of fixing the light controller 130 by the pivoting mechanism using the fixing member 171a. However, the present invention is not limited to this example, and the light controller 130 may be fixed by another mechanism. A modification of the attachment and detachment mechanism will be described with reference to FIGS. 13 to 15. FIG. 13 is a perspective view illustrating a part of a light controller 230 and a part of an extended portion 250a according to a modification. FIG. 14 is a front view of the light controller 230 and the extended portion 250a according to the modification. FIG. 15 is a view schematically illustrating a cross section taken along arrow C-C in FIG. 14.

The light controller 230 illustrated in FIGS. 13 to 15 corresponds to the light controller 130, and the extended portion 250a corresponds to the extended portion 150a. As illustrated in FIG. 13, the extended portion 250a is formed with an opening 250a, or a space in which a part of a side surface is hollowed out. The opening 250a is a slit. When an attached portion 231a of the light controller 230 is inserted into the opening 250a, the light controller 230 is held.

As illustrated in FIG. 14, the attached portion 231a is formed in such a manner that the outer shape of the attached portion 231a abuts on the inner surface of the opening 250a. Accordingly, sliding the attached portion 231a into the opening 250a determines the position of the attached portion 231a and fixes the attached portion 231a to the opening 250a.

Furthermore, as illustrated in FIG. 15, when the attached portion 231a is inserted into the opening 250a, an electrode 236a disposed in the attached portion 231a and a conductor 254a disposed in the extended portion 250a abut each other. Similarly, an electrode 235a and a conductor 253a abut each other. Such a configuration enables conduction of electricity between the light controller 230 and the head mounted display 100.

Although not described, an attached portion corresponding to the attached portion 131b and an extended portion corresponding to the extended portion 150b have similar mechanisms to those illustrated in FIGS. 13 to 15.

In this manner, even the attachment and detachment mechanism according to the modification enables the light controller 230 to be attached to or detached from the head mounted display 100 and enables conduction of electricity between the light controller 230 and the head mounted display 100 when the light controller 230 is attached to the head mounted display 100.

### 4. Wiring Pattern

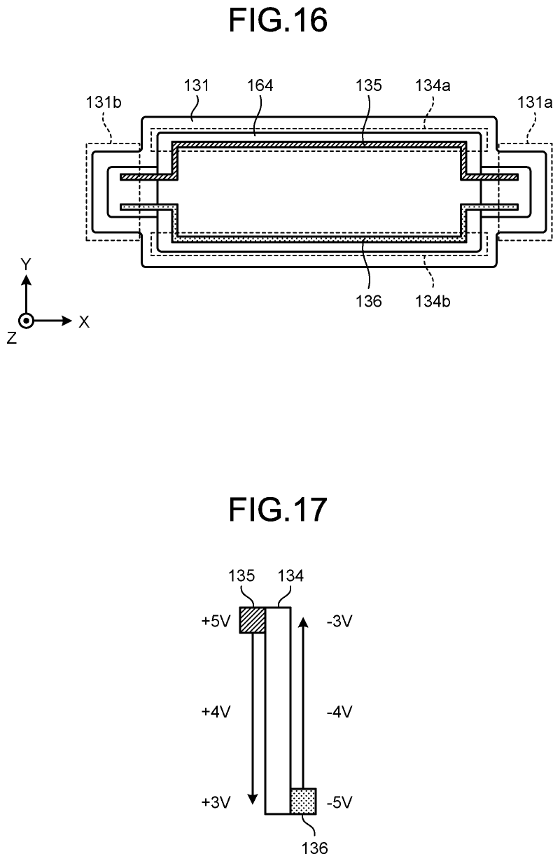

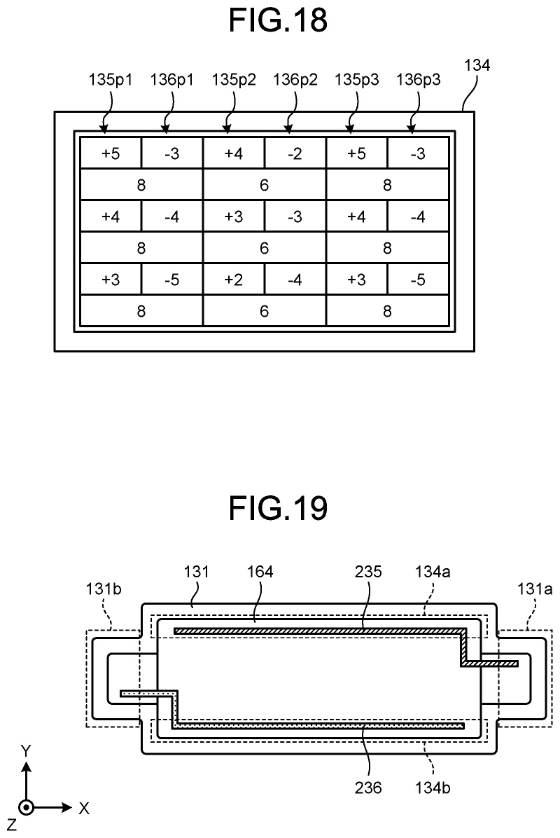

Next, the wiring pattern of the light controller 130 will be described with reference to FIGS. 16 to 18. FIG. 16 is a front view schematically illustrating the light controller 130 according to the embodiment. FIG. 16 schematically illustrates the light controller 130 in FIG. 8, but for the sake of convenience, the wires 135 and 136 are indicated by solid lines. FIG. 17 is a view for explaining applied voltages. FIG. 18 is a view illustrating examples of voltages applied to the light controlling material 134.

As illustrated in FIG. 16, the wires 135 and 136 are respectively disposed on an outer peripheral portion 134a and an outer peripheral portion 134b, that is, both ends in a direction intersecting the direction that connects the pair of attached portions 131a and 1321b in a plan view of the light controller 130 (or the cover plate 132 or the like serving as the base material). Specifically, the positive electrode wire 135 connects the electrode 135a of one attached portion 131a and the electrode 135b of the other attached portion 131b through one outer peripheral portion 134a. In other words, the positive electrode wire 135 extends from one attached portion 131a to the other attached portion 131b through one outer peripheral portion 134a. The negative electrode wire 136 connects the electrode 135a of one attached portion 131a and the electrode 135b of the other attached portion 131b through the other outer peripheral portion 134b. In other words, the negative electrode wire 136 extends from one attached portion 131a to the other attached portion 131b through the other outer peripheral portion 134b.

FIG. 17 illustrates an image of voltages applied to the light controlling material 134 by the wires 135 and 136. The voltages illustrated in FIG. 17 are examples, and the present invention is not limited to these values. As in FIG. 17, a voltage of +5 V is applied to the positive electrode wire 135. In this case, a voltage of +5 V is applied to the vicinity of the wire 135 (or around the outer peripheral portion 134a). However, a lower voltage is applied to an area farther from the wire 135. For example, a voltage of +3 V is applied on the opposite side of the wire 135 (that is, around the outer peripheral portion 134b). Similarly, a voltage of −5 V is applied to the negative electrode wire 136. In this case, a voltage of −5 V is applied to the vicinity of the wire 136, but a voltage of, for example, −3 V is applied to the opposite side of the wire 136.

Furthermore, in the wire 135, the applied voltage does not decrease near the attached portion 131a where the electrode 135a is disposed or near the attached portion 131b where the electrode 135b is disposed, but the applied voltage decreases at a central part of the outer peripheral portion 134a which is far from the attached portion 131a and the attached portion 131b. For example, when a voltage of +5 V is applied to the positive electrode wire 135, a voltage applied to the vicinity of the attached portion 131a or the vicinity of the attached portion 131b is +5 V, but a voltage applied to the central part of the outer peripheral portion 134a is +4 V. A voltage is applied to the wire 136 in a similar manner.

The combination of voltages described above is illustrated in FIG. 18. FIG. 18 illustrates an image of a voltage applied to each area of the light controlling material 134. In the table illustrated in FIG. 18, the numbers “+5,” “+4,” and “+3” in the left column 135p1 indicate voltages to be applied from the positive electrode wire 135 to areas of the light controlling material 134 close to the attached portion 131b. As described above, a voltage of +5 V is applied to the upper left area near the attached portion 131b and near the wire 135. However, a lower voltage is applied to an area farther from the wire 135 (to a lower area), even though the area is close to the attached portion 131b. FIG. 18 illustrates an example in which the voltage drops to +4 V or +3 V as in FIG. 17.

In the table illustrated in FIG. 18, the numbers “−3,” “−4,” and “−5” in the second left column 136p1 indicate voltages to be applied from the negative electrode wire 136 to areas of the light controlling material 134 close to the attached portion 131b. As described above, a voltage of −5 V is applied to the lower left area near the attached portion 131b and near the wire 136. However, a lower voltage is applied to an area farther from the wire 136 (to an upper area), even though the area is close to the attached portion 131b. FIG. 18 illustrates an example in which the voltage drops to −4 V or −3 V.

FIG. 18 also illustrates a potential difference in each area. For example, in the light controlling material 134, areas near the attached portion 131b and the wire 135 (the upper left area) has a potential difference of “8” because voltages applied to the areas are +5 V and −3 V. Furthermore, areas near the attached portion 131b and between the wire 135 and the wire 136 (the middle left area) has a potential difference of “8” because voltages applied to the areas are +4 V and −4 V.

In the table illustrated in FIG. 18, the numbers “+4,” “+3,” and “+2” in the third left column 135p2 indicate voltages to be applied from the positive electrode wire 135 to central areas of the light controlling material 134 between the attached portion 131a and the attached portion 131b. As described above, since the applied voltage decreases in areas far from both of the attached portions 131a and 131a, the example in FIG. 18 shows reduction in voltage by 1 V as a whole as compared with the column 135p2.

Similarly, the column 136p2 illustrates examples of voltages applied from the negative electrode wire 136 to central areas of the light controlling material 134. The column 135p3 illustrates examples of voltages applied from the positive electrode wire 135 to areas of the light controlling material 134 close to the attached portion 131a. The column 136p3 illustrates examples of voltages applied from the negative electrode wire 136 to areas of the light controlling material 134 close to the attached portion 131a.

The larger the potential difference between the positive electrode and the negative electrode, the further the transmittance of the light controlling material 134 decreases. Therefore, a variation in potential difference between the areas of the light controlling material 134 varies the transmittance of each area and generates an uneven image, which brings discomfort to a watcher. In addition, the larger the potential difference between the positive electrode and the negative electrode, the faster the reaction speed becomes to decrease the transmittance of the light controlling material 134. Therefore, a variation in potential difference between the areas of the light controlling material 134 varies the speed of each area to change the transmittance, and this brings discomfort to a watcher.

In FIG. 18, for example, potential differences between the areas of the light controlling material 134 are “6” to “8.” That is, there is little variation in potential difference. Particularly, potential differences in the right and left areas are “8,” “8,” and “8” from the top, showing that there is no variation. Potential differences in the upper and lower areas are both “8,” “6,” and “8” from the left, showing the same pattern. In the right and left areas, potential differences are both “8” and large, which enables quick reduction of the transmittance. For these reasons, in the wiring pattern of FIG. 16, the right and left areas of the light controlling material 134 have similar properties, and the upper and lower areas of the light controlling material 134 have similar properties. Accordingly, it is possible to prevent a watcher from feeling unevenness in an image.

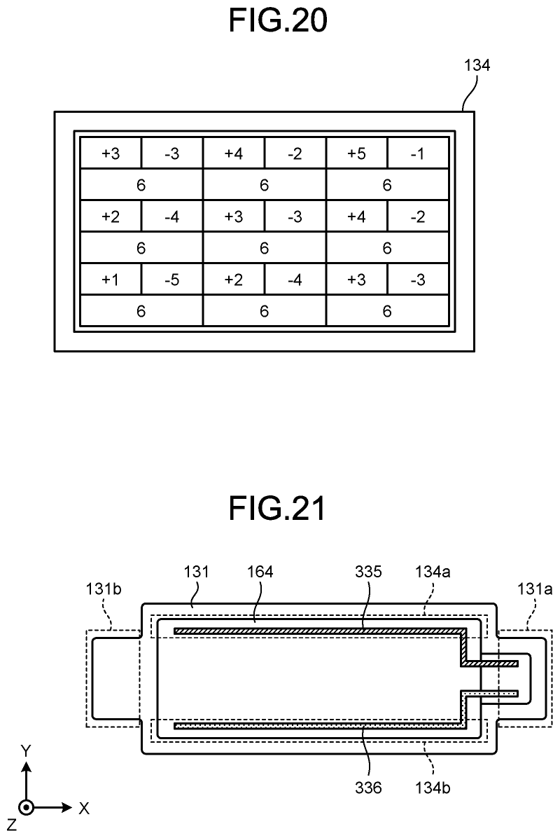

The wiring pattern of the light controller 130 is not limited to the example in FIG. 16. Hereinafter, other examples of the wiring pattern will be described with reference to FIGS. 19 to 26. FIGS. 19, 21, 23, and 25 are views illustrating examples of a wiring pattern according to modifications. FIGS. 20, 22, 24, and 26 are views illustrating examples of voltages applied to the light controlling material 134 according to the modifications. The conditions of the applied voltages illustrated in FIG. 20 and the like are similar to as those in FIG. 17.

In FIG. 19, for example, a positive electrode wire 235 extends from one attached portion 131a to an area before the other attached portion 131b through one outer peripheral portion 134a. That is, one end of the wire 235 is connected to the electrode 135a, but the other end of the wire 235 is not connected to the electrode 135b. In addition, a negative electrode wire 236 extends from the other attached portion 131b to an area before one attached portion 131a through the other outer peripheral portion 134b. That is, one end of the wire 236 is connected to the electrode 136b, but the other end of the wire 235 is not connected to the electrode 136a. In FIG. 16, for example, the attached portion 131a is not necessarily provided with the electrode 136a, and the attached portion 131b is not necessarily provided with the electrode 135b. In the wiring patterns illustrated in FIGS. 19, 21, and 23, when a wire extends to the attached portion 131a or the attached portion 131b, the wire is regarded as being connected to an electrode disposed in the attached portion 131a or the attached portion 131b.

In FIG. 19, for example, since one ends of the wires 235 and 236 do not conduct electricity between the electrodes, applied voltages decrease toward the other ends with no electrical conduction between the electrodes. FIG. 20 illustrates examples of applied voltages in the wiring pattern in FIG. 19. As illustrated in FIG. 20, potential differences on both ends of the light controlling material 134 are lower than those illustrated in FIG. 18, but the potential differences between the areas in FIG. 20 are equal to each other. That is, in the wiring pattern of FIG. 18, the right and left areas as well as the upper and lower areas of the light controlling material 134 have similar properties. Accordingly, it is possible to prevent a watcher from feeling unevenness in an image.

In FIG. 21, for example, a positive electrode wire 335 extends from one attached portion 131a to an area before the other attached portion 131b through one outer peripheral portion 134a. The positive electrode wire 335 is similar to the wire 235 illustrated in FIG. 19. In addition, a negative electrode wire 336 extends from one attached portion 131a to an area before the other attached portion 131b through the other outer peripheral portion 134b.

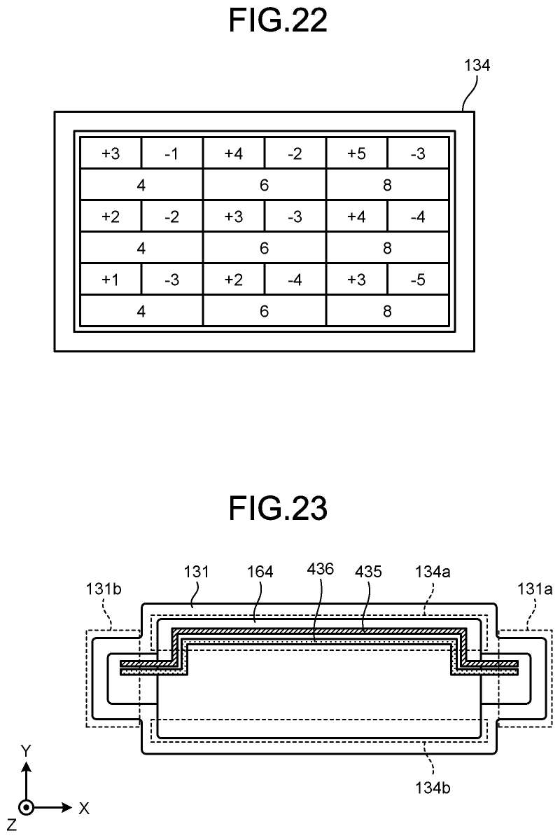

In FIG. 21, for example, since the positive electrode wire 335 and the negative electrode wire 336 do not conduct electricity between electrodes on the attached portion 131b, applied voltages to the areas on the attached portion 131b of the light controlling material 134 are decreased as a whole. FIG. 22 illustrates examples of applied voltages in the wiring pattern in FIG. 21. As illustrated in FIG. 22, applied voltages on the attached portion 131b of the light controlling material 134 are decreased, but potential differences in the upper and lower areas have a similar pattern. Accordingly, it is possible to prevent a watcher from feeling unevenness in an image from the top to bottom. Furthermore, in the wiring pattern in FIG. 21, an electrode may be disposed only on the attached portion 131a, and a conductor may be disposed only on the extended portion 150a. This makes it possible to reduce the manufacturing cost in the example illustrated in FIG. 21.

In FIG. 23, for example, a positive electrode wire 435 and a negative electrode wire 436 extend from one attached portion 131a to the other attached portion 131b through one outer peripheral portion 134a. Specifically, the positive electrode wire 435 connects the electrode 135a of one attached portion 131a and the electrode 135b of the other attached portion 131b through one outer peripheral portion 134a. In addition, the negative electrode wire 436 connects the electrode 136a and the electrode 136b through one outer peripheral portion 134a.

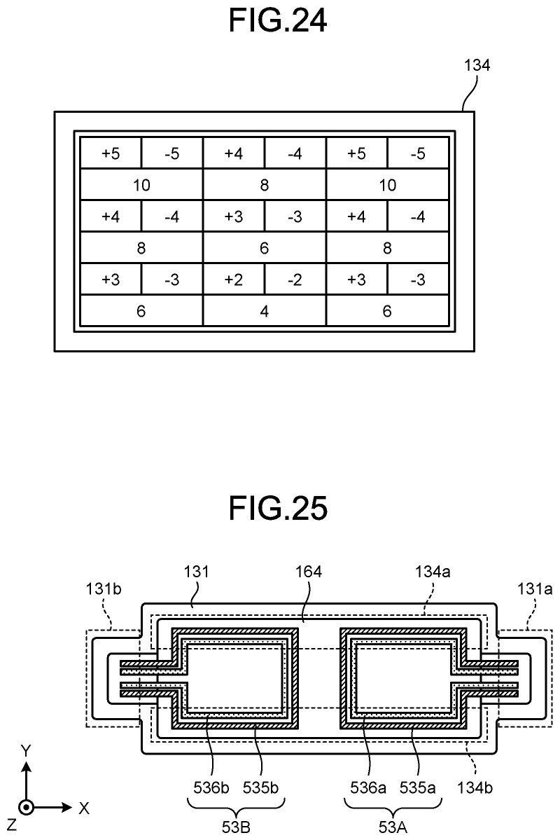

FIG. 24 illustrates examples of applied voltages in the wiring pattern in FIG. 23. As illustrated in FIG. 24, applied voltages in areas where the wires 435 and 436 are not disposed (near the outer peripheral portion 134b) are decreased, but potential differences between the right and left areas have a similar pattern. Accordingly, it is possible to prevent a watcher from feeling unevenness in an image from the right to left. Since the upper areas where the wires 435 and 436 are disposed (near the outer peripheral portion 134a) have large potential differences, it is possible to enhance the properties in the upper areas of the light controlling material 134. Furthermore, in FIG. 23, for example, there is no wire at lower parts. Accordingly, it is possible to broaden the display area, which provides a watcher with a wide field of view. Depending on the head mounted display, the upper areas of the light controller 130 may overlap with the substrate 140 of the frame 110. When the wiring pattern illustrated in FIG. 23 is applied to such a head mounted display, it is possible to hide the wiring pattern.

In FIG. 25, for example, a positive electrode wire 535a and a negative electrode wire 536a included in a first wire unit 53A extend from one attached portion 131a to one attached portion 131a through one outer peripheral portion 134a, a central part of the light controlling material 134, and the other outer peripheral portion 134b. In addition, a positive electrode wire 535b and a negative electrode wire 536b included in a second wire unit 53B extend from the other attached portion 131b to the other attached portion 131b through one outer peripheral portion 134a, a central part of the light controlling material 134, and the other outer peripheral portion 134b. That is, among two divided areas of the light controlling material 134 on the side close to the attached portion 131a and on the side close to the attached portion 131b, the first wire unit 53A is disposed on the outer peripheral portion of the area on the side close to the attached portion 131a. The second wire unit 53B is disposed on the outer peripheral portion of the area on the side close to the attached portion 131b.

In FIG. 25, for example, one end of the wire 535a is connected to the electrode 135a of the attached portion 131a, but the other end of the wire 535a is not connected to the electrode. One end of the wire 536a is connected to the electrode 136a of the attached portion 131a, but the other end of the wire 536a is not connected to the electrode. The upper side of FIG. 15 herein indicates one end and the lower side indicates the other end. The wires 535b and 536b are disposed in a similar manner, and only the upper ends in FIG. 15 are connected to the electrodes disposed in the attached portion 131b.

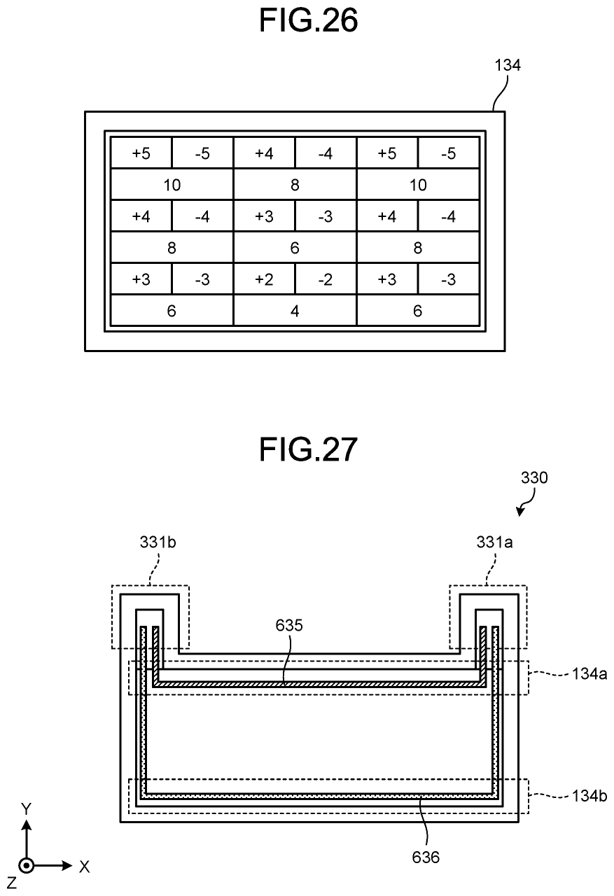

FIG. 26 illustrates examples of applied voltages in the wiring pattern in FIG. 25. As illustrated in FIG. 26, voltages applied to the other ends of the wires (the side not connected to the electrodes) are decreased, but upper areas (near the outer peripheral portion 134a) have large potential differences. Accordingly, it is possible to enhance the properties in the upper areas of the light controlling material 134. Furthermore, in FIG. 25, for example, potential differences in the right and left areas of the light controller 130 have a similar pattern. Accordingly, it is possible to prevent a watcher from feeling unevenness in an image from the right to left. In FIG. 25, for example, the right and left areas of the light controller 130 can be independently controlled. Accordingly, it is possible to provide an image depending on the intended use of the head mounted display 100.

### 5. Modification

Hereinafter described are modifications of the aforementioned head mounted display 100.

### 5-1. Light Controller (1)

In the above embodiment, the light controller 130 is attached to and detached from the extended portions 150a and 150b. However, the present invention is not limited to this example. This point will be described with reference to FIG. 27. FIG. 27 is a front view schematically illustrating a light controller 330 according to a modification.

As illustrated in FIG. 27, the light controller 330 according to the modification has a shape in which both ends of one side of a substantially rectangular shape protrude in the same direction. The protruding areas correspond to attached portions 331a and 331b. In this case, attaching and detaching units to which the attached portions 331a and 331b are detachably attached are disposed on one surface 140a of the substrate 140. The attaching and detaching units disposed on the substrate 140 may be those illustrated in FIG. 9 or FIG. 13. In this manner, the shape of the light controller 130 applied to the head mounted display 100 can be changed appropriately.

In FIG. 27, for example, a positive electrode wire 635 extends from one attached portion 331a to the other attached portion 331b through one outer peripheral portion 134a. Furthermore, a negative electrode wire 636 extends from one attached portion 331a to the other attached portion 331b through the other outer peripheral portion 134b. However, the present invention is not limited to this example, and the wiring pattern illustrated in FIG. 27 can be changed to the wiring patterns illustrated in FIGS. 19, 21, 23, and 25.

### 5-2. Light Controller (2)

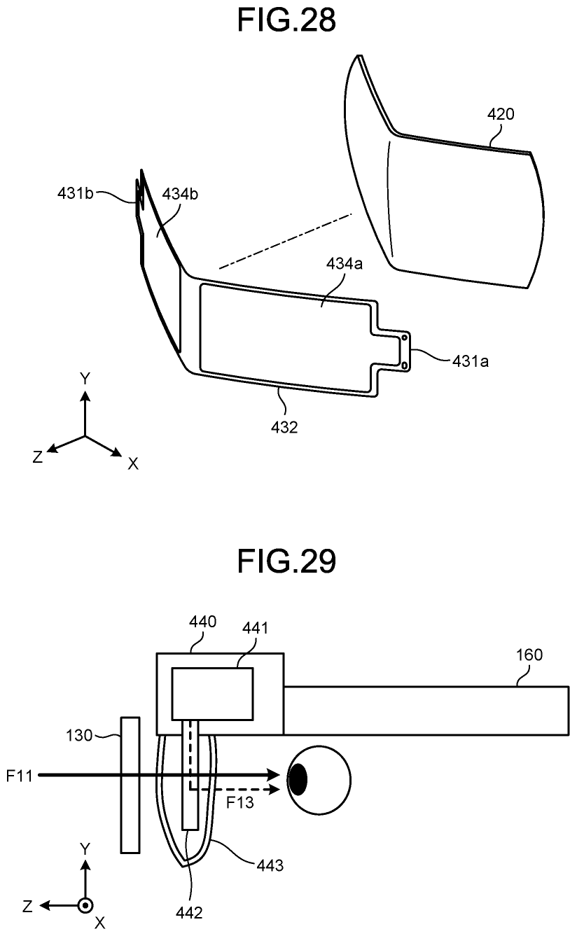

In the above embodiment, the light controller 130 includes the single light controlling material 134. However, the present invention is not limited to this example, and a plurality of light controlling materials may be contained in a layer. This point will be described with reference to FIG. 28. FIG. 28 is a perspective view schematically illustrating an optical member 420 and a light controller 430 according to a modification.

As illustrated in FIG. 28, the optical member 420 according to the modification has a shape bent at a central part. Specifically, the optical member 420 is curved from both ends to the central part with a predetermined curvature X (≥0), and the central part of the optical member 420 is curved at a curvature Y larger than the curvature X. The optical member 420 may be flat from both the ends to the central part instead of being curved.

The light controller 430 according to the modification includes a cover plate 432 and light controlling materials 434a and 434b. The light controller 430 has parts corresponding to the cover plate 132, the lower plate 133, the light controlling material 134, the wires 135 and 136, the adhesive member 137, and the upper plate 138 illustrated in FIG. 5, but the drawing illustrates the cover plate 432 corresponding to the cover plate 132.

In two divided areas of the cover plate 432 which are on a side close to an attached portion 431a and a side close to an attached portion 431b, the light controlling material 434a is disposed on the area on the side close to the attached portion 431a. Furthermore, the light controlling material 434b is disposed in the area on the side close to the attached portion 431b. The light controlling material 434a and the light controlling material 434b are disposed in the areas not to overlap with each other. The areas provided with the light controlling materials 434a and 434b are less flexible and less likely to curve than an area between the light controlling material 434a and the light controlling material 434b (that is, an area with no light controlling material).

That is, as illustrated in FIG. 28, when the light controller 430 is mounted on the frame 110, the area between the light controlling material 434a and the light controlling material 434b is curved to a greater degree than the areas provided with the light controlling materials 434a and 434b. Accordingly, the light controller 430 is mounted on the frame 110 while being curved along the curved shape of the optical member 420. Dividing and sealing the light controlling materials in this way make it possible to control the mode of curving of the light controller 430.

### 5-3. Image Output

In the above embodiment, for example, an image is provided to a watcher by the optical member 120 such as a half mirror. However, the present invention is not limited to this example. This point will be described with reference to FIG. 29. FIG. 29 is a view schematically illustrating a cross section of a head mounted display according to a modification.

As illustrated in FIG. 29, a substrate 440 according to the modification include an optical engine 441. The optical engine 441 is, for example, a display device or an optical lens. As similar to the display device 141, the optical engine 441 emits an image for presenting various kinds of images and information to a watcher.

A light guide plate 442, or an optical member, is connected to the optical engine 441. The light guide plate 442 guides an image output from the optical engine 441 and provides the image to a watcher in direction F13 illustrated in FIG. 29. The light guide plate 442 includes a transparent member that enables transmission of external light. Examples of the light guide plate 121 include a hologram light guide plate and a dielectric multilayer film light guide plate. The example in FIG. 29 also illustrates a transparent resin visor 443 for protecting the light guide plate 442.

### 5-4. Size of Light Controller

As illustrated in FIG. 4, a length of the light controller 130 in the vertical direction (extending direction of the optical member 120) is shorter than a length of the optical member 120 in the vertical direction (extending direction of the optical member 120). However, the present invention is not limited to this example, and the vertical length of the light controller 130 may be equal to or larger than the vertical length of the optical member 120. That is, the light controller 130 may have a size that covers the entire optical members 120 in a plan view. Furthermore, an upper part of the light controller 130 may be extended to a position where it overlaps with the substrate 140 in a plan view. Accordingly, a wire disposed on the upper part of the light controller 130 enters a blind spot of the substrate 140 and becomes out of watcher's line of vision.

### 5-5. Shape of Light Controller

As illustrated in FIGS. 7 and 8, the light controller 130 protrudes from the central parts of both the sides of the substantially rectangular shape. Accordingly, the attached portions 131a and 131b disposed in the central parts of the light controller 130 are held so that the light controller 130 is curved evenly. However, the present invention is not limited to this example, and the light controller 130 may protrude from the whole extent of each side of the substantially rectangular shape. In this case, both ends of the substantially rectangular shape correspond to the attached portions 131a and 131b. Alternatively, the light controller 130 may protrude from upper or lower portions of both sides of the substantially rectangular shape instead of from the central parts of both sides of the substantially rectangular shape.

### 5-6. Positioning Mechanism

The positioning mechanism is not limited to the aforementioned example. For example, the frame 110 may have either the positioning pin 152a1 or the positioning pin 152a2. In this case, the light controller 130 is formed with a positioning hole corresponding to the positioning pin of the frame 110. The extended portion 150b has a similar positioning mechanism.

### 5-7. Application

In the above embodiment, the head mounted display 100 is illustrated as an example of the AR device, but the present invention is not limited to this example. Specifically, the embodiment can be applied to any device as long as it is a head mounted device such as eyeglasses including a light controller that changes in transmittance along with the application of a voltage.

### 6. Effect

As described above, the head mounted display 100 according to the embodiment includes the frame 110 and the optical member 120. The optical member 120 is fixed to the frame 110 to provide an image. The frame 110 includes a pair of attaching and detaching units 170a and 170b to which both the ends (corresponding to the attached portions 131a and 131b) of the light controller 130 are detachably attached. The pair of attaching and detaching units 170a and 170b holds the light controller 130 while the optical member 120 and the light controller 130 are separated from each other. At least one of the pair of attaching and detaching units 170a and 170b is electrically connected to at least one of both the ends of the light controller 130.

According to the head mounted display 100, mounting the detachable light controller 130 on the frame 110 enables electrical connection between the light controller 130 and the frame 110, which enhances the head mounted display 100 in operability. For example, a watcher can use the head mounted display 100 with 100% of transmittance by detaching the light controller 130. Furthermore, by attaching different types of light controllers 130 to the head mounted display 100 depending on the intended use, a watcher can use the head mounted display 100 with a suitable light controller 130 for various scenes.

Furthermore, the pair of attaching and detaching units 170a and 170b holds the light controller 130 in a curved state.

Such a configuration enables dispersion of an external force applied to the light controller 130, which makes it difficult to apply an external force to the optical member 120 and eventually prevents deterioration of the head mounted display 100 in display performance. What is more, it is possible to enhance the design of the head mounted display 100.

Furthermore, the pair of attaching and detaching units 170a and 170b holds the light controller 130 in a curved state, but the light controller 130 has a flat-plate shape when not being attached.

According to the head mounted display 100, the light controller 130 is curved only when it is not mounted, which makes it easy to carry the light controller 130. Accordingly, it is possible to enhance the head mounted display 100 in operability.

Furthermore, the pair of attaching and detaching units 170a and 170b holds the light controller 130 with the light controller 130 being curved in such a manner that both the ends of the light controller 130 approach each other.

That is, according to the head mounted display 100, the light controller 130 is curved in such a manner that the attached portions 131a and 131b which are both the ends of the light controller 130 approach each other. Accordingly, the attached portions 131a and 131b themselves are not substantially curved. This makes it possible to prevent the electrode 135a and the like from being deformed or damaged by curving.

Furthermore, the pair of attaching and detaching units 170a and 170b holds the light controller 130 on the side of the optical member 120 opposite to the side where an image is provided.

Accordingly, the light controller 130 is disposed on the outer side of the head mounted display 100, which makes it difficult to apply an external force to the optical member 120 and prevents deterioration of the head mounted display 100 in display performance.

The optical member 120 has a surface that provides an image and a surface opposite to the surface, and the surface providing an image is configured to reflect light and the opposite surface is configured to transmit light.

Such a configuration enhances the operability of the head mounted display 100 that achieves AR.

The frame 110 includes the flat-plate shaped substrate 140 and the pair of flat-plate shaped extended portions 150a and 150b extending from one surface 140a of the substrate 140 in a predetermined direction. The optical member 120 is sandwiched between the pair of extended portions 150a and 150b and extends in a predetermined direction from one surface 140a. The pair of attaching and detaching units 170a and 170b is disposed on the pair of extended portions 150a and 150b and holds both the ends of the light controller 130 in such a manner that the light controller 130 covers the optical member 120.

That is, since the attached portions 131a and 131b are attached to the pair of flat-plate shaped extended portions 150a and 150b, the attached portions 131a and 131b are less likely to curve. That is, the attached portions 131a and 131b themselves are difficult to curve. That is, since the electrodes 135a and 135b are less likely to curve, it is possible to prevent the electrodes 135a and the like from being deformed or damaged.

Furthermore, the frame 110 includes the conductors (corresponding to the conductors 153a, 154a, 153b, 154b) that are electrically connected to the light controller 130, and the waterproof member 155a that is disposed around the conductors and seals the conductors when being pressed against the light controller 130.

Accordingly, it is possible to reliably protect electric parts from water and dust.

The frame 110 includes a first positioning member (corresponding to the positioning pin 152a1) which is inserted into a first hole (corresponding to the positioning hole 132a1) formed in the light controller 130 and a second positioning member (corresponding to the positioning pin 152a2) which is placed at a position separated from the first positioning member and is inserted into a second hole (corresponding to the positioning hole 132a2) formed in the light controller 130.

Such a configuration enables a watcher to easily attach the light controller 130 to the frame 110.

The light controller 130 according to the embodiment includes the flexible flat-plate shaped base material (corresponding to the cover plate 132, the lower plate 133, the adhesive member 137, and the upper plate 138), the flat-plate shaped light controlling material 134 sealed to the base material, the attached portions 131a and 131b, and the electrical connector (corresponding to the electrodes 135a and 135b). The pair of attached portions 131a and 131b is disposed at both ends of the base material and detachably attached to the pair of attaching and detaching units 170a and 170b of the frame 110 of the head mounted display 100. The electrical connectors are disposed on at least one of the pair of attached portions 131a and 131b and are electrically connected to at least one of the pair of attaching and detaching units 170a and 170b of the frame 110.

With such a configuration, the light controller 130 can be detachably attached to the head mounted display 100 and can be electrically connected to the head mounted display 100 by being attached to the head mounted display 100. Accordingly, it is possible to enhance the light controller 130 in operability.

The length connecting the pair of attached portions 131a and 131b is longer than the length connecting the pair of attaching and detaching units 170a and 170b of the frame 110.

With such a configuration, the light controller 130 is curved when being attached to the head mounted display 100. Accordingly, it is possible to enhance the design of the head mounted display 100.

It should be noted that the effects described herein are for the purposes of illustration and not limitation and that the techniques according to the present disclosure may achieve other effects. In other words, in addition to or in place of the above effects, the techniques according to this disclosure may exhibit other effects which are apparent to those skilled in the art from the description herein.

The present technology may also have the following configurations.

(1)

A head mounted display comprising:

a frame; and

an optical member fixed to the frame and configured to provide an image,

wherein the frame includes a pair of attaching and detaching units to which both ends of a light controller are detachably attached, and

at least one of the pair of attaching and detaching units is electrically connected to at least one of the both ends of the light controller.

(2)

The head mounted display according to (1),

wherein the pair of attaching and detaching units holds the light controller with the optical member and the light controller being separated from each other.

(3)

The head mounted display according to (1) or (2),

wherein the pair of attaching and detaching units holds the light controller with the light controller being curved.

(4)

The head mounted display according to (3),

wherein the pair of attaching and detaching units holds the light controller with the light controller being curved, the light controller having a flat-plate shape when not being attached.

(5)

The head mounted display according to (3) or (4),

wherein the pair of attaching and detaching units holds the light controller with the light controller being curved in such a manner that the both ends of the light controller approach each other.

(6)

The head mounted display according to any one of (1) to (5),

wherein the pair of attaching and detaching units holds the light controller on a side of the optical member opposite to a side provided with the image.

(7)

The head mounted display according to any one of (1) to (6),

wherein the optical member has a surface that provides the image and a surface opposite to the surface, the surface providing the image being configured to reflect light and the opposite surface being configured to transmit light.

(8)

The head mounted display according to any one of (1) to (7),

wherein the frame includes a substrate having a flat-plate shape and a pair of extended portions extending in a predetermined direction from one surface of the substrate and having a flat-plate shape,

the optical member is sandwiched between the pair of extended portions and extended from one surface in the predetermined direction, and

the pair of attaching and detaching units is disposed on the pair of extended portions and configured to hold the both ends of the light controller in such a manner that the light controller covers the optical member.

(9)

The head mounted display according to any one of (1) to (8),

wherein the frame includes:

a conductor electrically connected to the light controller; and

a waterproof member disposed around the conductor and configured to seal the conductor when being pressed against the light controller.

(10)

The head mounted display according to any one of (1) to (9),

wherein the frame includes:

a first positioning member inserted into a first hole formed in the light controller; and

a second positioning member disposed at a position separated from the first positioning member and inserted into a second hole formed in the light controller.

(11)

A light controller comprising:

a base material having flexibility and a flat-plate shape;

a light controlling material disposed on the base material and having a flat-plate shape;

a pair of attached portions disposed at both ends of the base material and detachably attached to a pair of attaching and detaching units of a frame of a head mounted display; and

an electrical connector disposed on at least one of the pair of attached portions and electrically connected to at least one of the pair of attaching and detaching units of the frame.

(12)

The light controller according to (11),

wherein a length that connects the pair of attached portions is longer than a length that connects the pair of attaching and detaching units of the frame.

(13)

The light controller according to (11) or (12), further comprising:

a positive electrode wire and a negative electrode wire disposed on respective outer peripheral portions at both ends of the light controller in a direction intersecting with a direction connecting the pair of attached portions in a plan view of the base material.

(14)

The light controller according to (13),

wherein the positive electrode wire extends from one attached portion to another attached portion through one outer peripheral portion, and

the negative electrode wire extends from one attached portion to the other attached portion through another outer peripheral portion.

(15) The light controller according to (13),

wherein the positive electrode wire extends from one attached portion to an area before another attached portion through one outer peripheral portion, and

the negative electrode wire extends from the other attached portion to an area before one attached portion through another outer peripheral portion.

(16)

The light controller according to (13),

wherein the positive electrode wire extends from one attached portion to an area before another attached portion through one outer peripheral portion, and

the negative electrode wire extends from one attached portion to the area before the other attached portion through another outer peripheral portion.

(17)

The light controller according to (13),

wherein the positive electrode wire and the negative electrode wire extend from one attached portion to another attached portion through one outer peripheral portion.

(18)

The light controller according to (13), comprising, as the positive electrode wire and the negative electrode wire:

a first positive electrode wire and a first negative electrode wire extending from one attached portion to one attached portion through one outer peripheral portion, a central part of the light controlling material, and another outer peripheral portion; and

a second positive electrode wire and a second negative electrode wire extending from another attached portion to the other attached portion through one outer peripheral portion, the central part of the light controlling material, and another outer peripheral portion.

(19)

The light controller according to any one of (11) to (18),

wherein the light controlling material includes a first light controlling material disposed in an area of the base material close to one attached portion and a second light controlling material disposed in an area of the base material close to another attached portion, the area close to the other attached portion not overlapping with the area close to one attached portion, and

the areas provided with the first light controlling material and the second light controlling material have lower flexibility than an area between the first light controlling material and the second light controlling material.

(20)

The light controller according to any one of (11) to (19), wherein the light controller is an electrochromic device.

### REFERENCE SIGNS LIST

100 HEAD MOUNTED DISPLAY
110 FRAME
120 OPTICAL MEMBER
130 LIGHT CONTROLLER
140 SUBSTRATE
150a, 150b EXTENDED PORTION
170a, 170b ATTACHING AND DETACHING UNIT

1. A head mounted display comprising:
a frame; and
an optical member fixed to the frame and configured to provide an image,
wherein the frame includes a pair of attaching and detaching units to which both ends of a light controller are detachably attached, and
at least one of the pair of attaching and detaching units is electrically connected to at least one of the both ends of the light controller.

2. The head mounted display according to claim 1,
wherein the pair of attaching and detaching units holds the light controller with the optical member and the light controller being separated from each other.

3. The head mounted display according to claim 1,
wherein the pair of attaching and detaching units holds the light controller with the light controller being curved.

4. The head mounted display according to claim 3,
wherein the pair of attaching and detaching units holds the light controller with the light controller being curved, the light controller having a flat-plate shape when not being attached.

5. The head mounted display according to claim 3,
wherein the pair of attaching and detaching units holds the light controller with the light controller being curved in such a manner that the both ends of the light controller approach each other.

6. The head mounted display according to claim 1,
wherein the pair of attaching and detaching units holds the light controller on a side of the optical member opposite to a side provided with the image.

7. The head mounted display according to claim 1,
wherein the optical member has a surface that provides the image and a surface opposite to the surface, the surface providing the image being configured to reflect light and the opposite surface being configured to transmit light.

8. The head mounted display according to claim 1,
wherein the frame includes a substrate having a flat-plate shape and a pair of extended portions extending in a predetermined direction from one surface of the substrate and having a flat-plate shape,
the optical member is sandwiched between the pair of extended portions and extended from one surface in the predetermined direction, and
the pair of attaching and detaching units is disposed on the pair of extended portions and configured to hold the both ends of the light controller in such a manner that the light controller covers the optical member.

9. The head mounted display according to claim 1,
wherein the frame includes:
a conductor electrically connected to the light controller; and
a waterproof member disposed around the conductor and configured to seal the conductor when being pressed against the light controller.

10. The head mounted display according to claim 1,
wherein the frame includes:
a first positioning member inserted into a first hole formed in the light controller; and
a second positioning member disposed at a position separated from the first positioning member and inserted into a second hole formed in the light controller.

11. A light controller comprising:
a base material having flexibility and a flat-plate shape;
a light controlling material disposed on the base material and having a flat-plate shape;
a pair of attached portions disposed at both ends of the base material and detachably attached to a pair of attaching and detaching units of a frame of a head mounted display; and
an electrical connector disposed on at least one of the pair of attached portions and electrically connected to at least one of the pair of attaching and detaching units of the frame.

12. The light controller according to claim 11,
wherein a length that connects the pair of attached portions is longer than a length that connects the pair of attaching and detaching units of the frame.

13. The light controller according to claim 11, further comprising:
a positive electrode wire and a negative electrode wire disposed on respective outer peripheral portions at both ends of the light controller in a direction intersecting with a direction connecting the pair of attached portions in a plan view of the base material.

14. The light controller according to claim 13,
wherein the positive electrode wire extends from one attached portion to another attached portion through one outer peripheral portion, and
the negative electrode wire extends from one attached portion to the other attached portion through another outer peripheral portion.

15. The light controller according to claim 13,
wherein the positive electrode wire extends from one attached portion to an area before another attached portion through one outer peripheral portion, and
the negative electrode wire extends from the other attached portion to an area before one attached portion through another outer peripheral portion.

16. The light controller according to claim 13,
wherein the positive electrode wire extends from one attached portion to an area before another attached portion through one outer peripheral portion, and
the negative electrode wire extends from one attached portion to the area before the other attached portion through another outer peripheral portion.

17. The light controller according to claim 13,
wherein the positive electrode wire and the negative electrode wire extend from one attached portion to another attached portion through one outer peripheral portion.

18. The light controller according to claim 13, comprising, as the positive electrode wire and the negative electrode wire:
a first positive electrode wire and a first negative electrode wire extending from one attached portion to one attached portion through one outer peripheral portion, a central part of the light controlling material, and another outer peripheral portion; and
a second positive electrode wire and a second negative electrode wire extending from another attached portion to the other attached portion through one outer peripheral portion, the central part of the light controlling material, and another outer peripheral portion.

19. The light controller according to claim 11,
wherein the light controlling material includes a first light controlling material disposed in an area of the base material close to one attached portion and a second light controlling material disposed in an area of the base material close to another attached portion, the area close to the other attached portion not overlapping with the area close to one attached portion, and
the areas provided with the first light controlling material and the second light controlling material have lower flexibility than an area between the first light controlling material and the second light controlling material.

20. The light controller according to claim 11,
wherein the light controller is an electrochromic device.
